(19) United States
(12) Patent Application Publication
(10) Pub. No.: US 2012/0022919 A1
(43) Pub. Date: Jan. 26, 2012

(54) Privacy Ensured Polling

(75) Inventors: Helen Balinsky, Cardiff Wales (GB); Anthony Wiley, Bristol (GB); Keith Harrison, Chepstow Monmouthshire (GB); David Banks, Bristol (GB); Steven Battle, City of Bristol (GB)

(73) Assignee: HEWLETT-PACKARD DEVELOPMENT COMPANY, L.P., Houston, TX (US)

(21) Appl. No.: 13/259,185

(22) PCT Filed: Sep. 18, 2009
(86) PCT No.: PCT/US2009/057565

§ 371 Date: Sep. 23, 2011

(51) Int. Cl. G06Q 10/00

(52) U.S. Cl. 705/7.32

(57) ABSTRACT

A method for conducting a privacy ensured computerized poll includes, in a computerized anonymizing system (100), receiving a list (404) of invited participants (418) of said computerized poll, said list (404) comprising at least one address (202, 204) for each said participant (418). With said computerized anonymizing system (100), assigning each invited participant (418) in said poll at least one character string (410, 412) and transmitting to each invited participant (418) said at least one character string (410, 412) assigned to said participant (418) using said at least one address (202, 204). With said computerized anonymizing system (100), generating a list (408) comprising an entry for each said at least one character string (410, 412) assigned to one of said invited participants (418) and shuffling an order of said entries, and providing said shuffled list (408) to a poll initiator (402).

### BACKGROUND

Businesses, government entities, and other organizations often want to collect data from people to assist with decision making processes. This data may include opinions, views, or votes from people on a wide variety of topics or issues. However, many people may feel uncomfortable when giving their true opinions on certain topics for fear of judgment or discrimination. For example, an employer may want to survey employees to determine their opinion on a certain company policy. However, many people may be reluctant to give their true opinion for fear of offending others or in extreme circumstances, even losing their job. In a further example, a professor may wish to survey his or her students to help determine a more effective teaching method. However, students may be reluctant to give their true opinion in fear that it may negatively affect their grade.

Many polls and surveys are done electronically. Electronic polls that typically target specific individuals for polling often require some sort of login Identification (ID) and/or password to ensure that only the desired individuals participate in the poll. Doing so, however, allows the identity of a participant to be associated with his or her response. Though a poll initiator or someone conducting a poll may claim to not view the association between a participant and their responses, it may sometimes be difficult for participants to trust that the poll initiators will make sure that is the case.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram of an illustrative computerized anonymizing system, according to one embodiment of principles described herein.

FIG. 2A is a diagram of an illustrative list of participants, according to one embodiment of principles described herein.

FIG. 2B is a diagram of an illustrative list of random character strings, according to one embodiment of principles described herein.

FIG. 3 is a diagram illustrating the assignment of random character strings to mode of communication addresses of participants, according to one embodiment of principles described herein.

FIG. 4 is a diagram showing an illustrative privacy ensured polling process, according to one embodiment of principles described herein.

FIG. 5 is a diagram showing an illustrative user interface for setting up a poll, according to one embodiment of principles described herein.

FIGS. 6A and 6B are diagrams showing an illustrative user interface for completing and submitting a poll, according to one embodiment of principles described herein.

FIG. 7 is a flowchart showing an illustrative process for performing a privacy ensured poll, according to one embodiment of principles described herein.

Throughout the drawings, identical reference numbers designate similar, but not necessarily identical, elements.

### DETAILED DESCRIPTION

As mentioned above, businesses, government entities, and other organizations often want to collect data from people to assist with decision making processes. This data may include opinions, views, or votes from people on a wide variety of topics or issues. Opinions may be solicited and received by paper or electronically. However, many people may feel uncomfortable when giving their true opinions on certain topics for fear of judgment or discrimination.

Many polls and surveys are performed electronically. Electronic polls that target specific individuals for polling often require some sort of login Identification (ID) and password to ensure that only the desired individuals participate in the poll. Doing so, however, allows the identity of a participant to be tied with their response. Though a poll initiator or someone conducting a poll may claim to not view the association between a participant and their responses, it may sometimes be difficult for participants to trust that the poll initiators will make sure that is the case.

In light of these and other difficulties, the present specification relates to a polling method which ensures the privacy of the participant's responses. According to one illustrative embodiment, a computerized anonymizing system may receive from a poll initiator a list of participants. In the list of participants, each potential participant in a poll may be associated with at least one address for a mode of communication. Upon receipt of the list of participants, the computerized anonymizing system may generate at least one random character string for each participant on the list. The computerized anonymizing system may then send the generated random character strings to each participant on the list, with each random character string being sent to the address of a mode of communication associated with each participant. The computerized anonymizing system may also shuffle the list of random character strings assigned to each participant and send the list of the shuffled random character strings to the poll initiator.

The poll initiator may then use the list of random character strings to create a login access allowing participants to access a computerized poll. The computerized poll may be accessed by participants using the random character strings received from the computerized anonymizing system through the designated modes of communication. In this way, the participants may anonymously complete and submit the poll.

By using a computerized anonymizing system embodying principles described herein, the poll initiator may only see the responses as coming from random character strings. The poll initiator may have no way to link a random character string to a particular participant. Using this system may provide participants with the peace of mind that their responses are securely anonymous. It may also provide the poll initiator with a more accurate poll result.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

Throughout the present specification and the appended claims, the term “computerized anonymizing system” will refer to a system embodying principles described herein that anonymizes login data for participants of a poll. The term “poll” will refer to any poll, survey, questionnaire, vote, or form that requires participant input.

Throughout the present specification and the appended claims, the term “poll initiator” will refer to one who uses the computerized anonymizing system to set up a poll to be taken by a set of participants. The term “participant” will refer to one who takes, completes, or submits a poll.

Throughout the present specification and the appended claims, the term “mode of communication” will refer to a device or method of communication such as email, a cell phone, a physical letter, etc. The term “address” when applied to a mode of communication will refer to whatever means is used by the applied mode of communication to identify individual units. For example, the address for a cell phone would be a cell phone number; and the address for an email would be an email address.

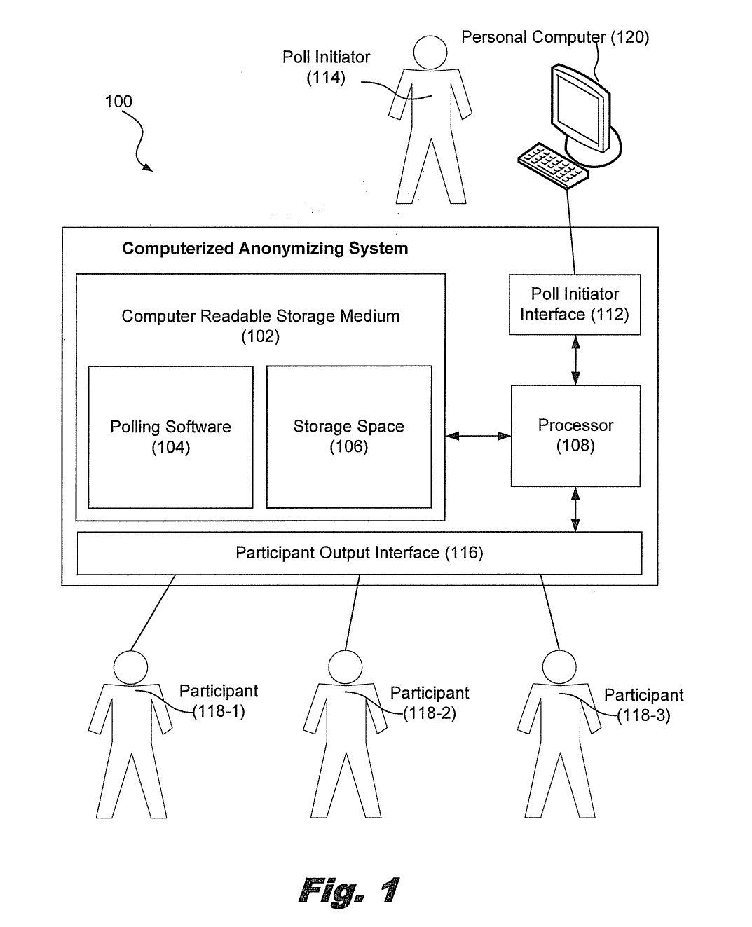

Referring now to the figures, FIG. 1 is a diagram of an illustrative computerized anonymizing system. According to one illustrative embodiment, a computerized anonymizing system may include a computer readable storage medium (102) having polling software (104) and storage space (106) thereon, a processor (108), a poll initiator interface (112), and a participant output interface (116).

The computer readable storage medium may be used to hold the polling software (104) and any additional storage space (106) needed. The storage medium (102) may be a type of memory including but not limited to a hard disk, flash memory, or firmware. The polling software (104) may contain computer readable code for algorithms and user interfaces used to accomplish the various tasks associated with the computerized anonymizing system (100). The additional storage space (106) may be used to store variables and other important data associated with the purposes of the computerized anonymizing system (100).

The poll initiator interface (112) includes the software and hardware which allows a poll initiator (114) to interact with the computerized anonymizing system, for example by providing a list of participants to the computerized anonymizing system, or receiving from the computerized anonymizing system a list of randomized login data for the participants. The participant output interface (116) may include hardware and software to provide data to participants (118-1, 118-2, 118-3) through one or more modes of communication. This data may include random character strings used to access a computerized poll.

In one embodiment, the computerized anonymizing system (100) may be embodied on an internet server. Personal computers operated by both the poll initiator (114) and the poll participants (118-1, 118-2, 118-3) may be used to access the computerized anonymizing system (100) via the server. For example, a poll initiator (114) may use his or her personal computer (120) to interface with the computerized anonymizing system (100) through the poll initiator interface (112). A poll participant (118-1, 118-2, 118-3) may receive an email from the computerized anonymizing system sent by the participant output interface (116) which the participant (118-1, 118-2, 118-3) may access from his or her personal computer.

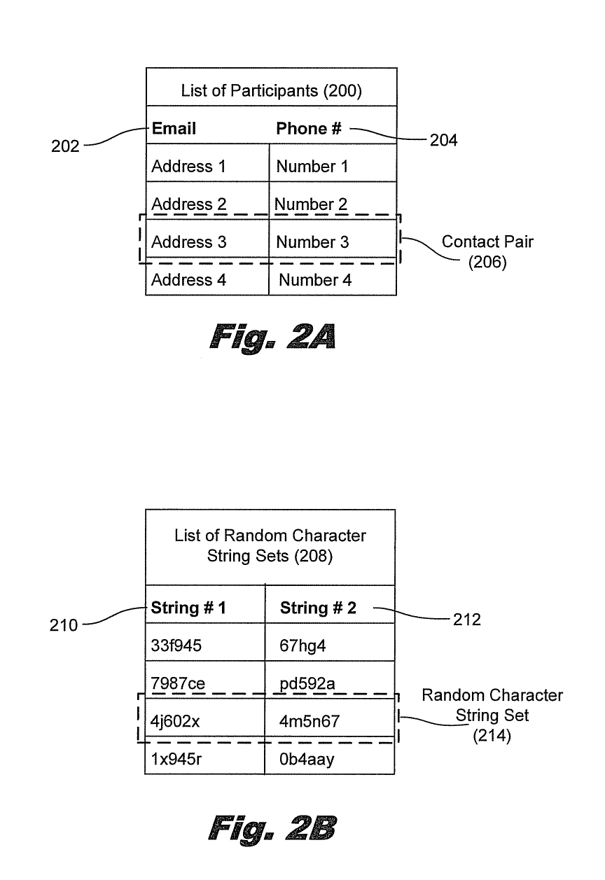

As mentioned above, a computerized anonymizing system (100) may be configured to receive a list of participants (118-1, 118-2, 118-3) from the poll initiator (114). FIG. 2A is a diagram of an illustrative list of participants (200). According to one illustrative embodiment, a list of participants may contain a number of participants and the address for at least one mode of communication for each participant. To increase security, more than one mode of communication may be associated with each invited participant. For example, for each participant in the list of participants (200), there may be a record of an associated email address (202) and a mobile phone number (204). Both addresses for the two different modes of communication may be referred to as a contact pair (206).

Upon receipt of such a list of participants (200), a computerized anonymizing system (100, FIG. 1) may be configured to generate a list of random character strings. FIG. 2B is a diagram of an illustrative list of random character string sets (208). According to one illustrative embodiment, the random character string list may include a number of random character strings (214) for each participant. To increase security, more than one random character string may be assigned to each invited participant. Each random character string set (214) may include a first random character string (210) and a second random character string (212). A random character string may be a string of random numbers, a string of other random alphanumeric characters are any combination of such.

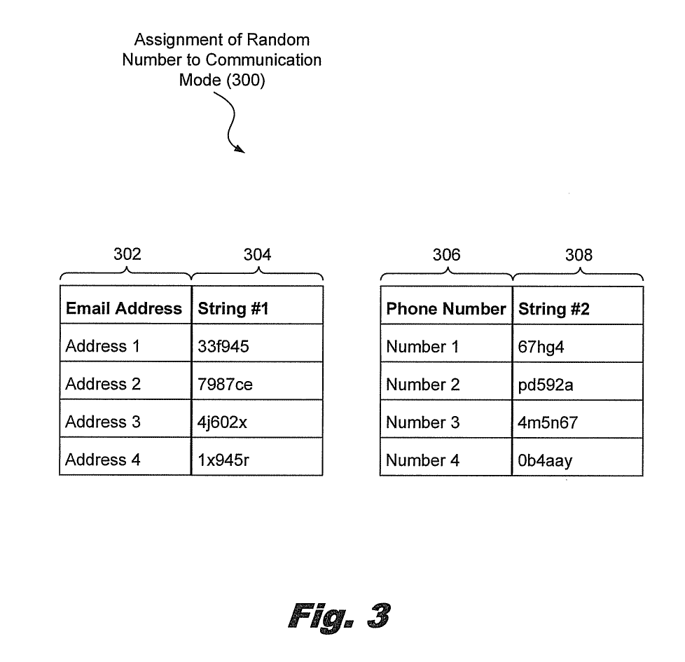

According to one illustrative embodiment, each contact pair (206) in the list of participants (200) may be assigned a random character strings (214). In one embodiment, if there are at least two random character strings assigned to a participant, one string from the random character string set (214) may be assigned to one address (202) for a mode of communication, and another string from the random character string pair (214) may be assigned to an address (204) for another mode of communication. FIG. 3 is a diagram illustrating the assignment (300) of random character strings to addresses for modes of communication.

Using the example mentioned above in which one mode of communication is email and the other mode of communication is a mobile phone, each participant from the participant list may be assigned a random character string set. The email address (302) for a participant may be associated with a first random character string (304) from the assigned random character string set and the phone number (306) for the participant may be associated with a second random character string (308) from the random character string set. In one embodiment, data that indicates the assignment of random character strings to a particular participant may remain encrypted on the computerized anonymizing system unless it becomes necessary to access the data (e.g., subpoenaed by a court) In such embodiments, the poll initiator may not have sufficient privileges in the system to decrypt and access this data.

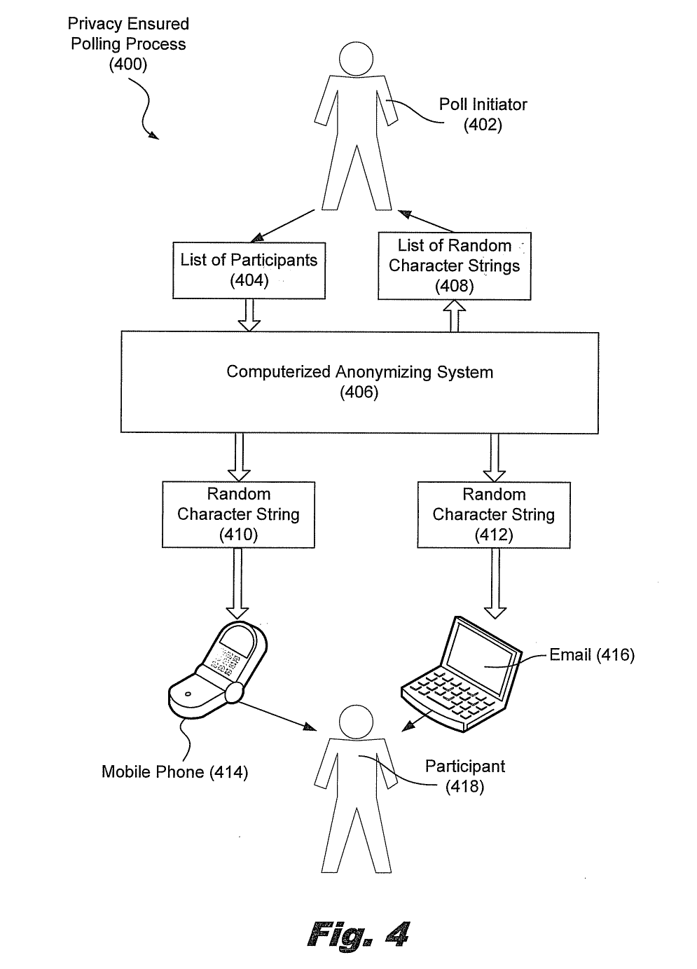

FIG. 4 is a diagram showing an illustrative privacy ensured polling process (400). According to one illustrative embodiment, a poll initiator provides a computerized anonymizing system (406) with a list of participants (404). Random character strings (410, 412) may then be generated by the computerized anonymizing system (406) and assigned to each participant (418) from the received list of participants (404). The computerized anonymizing system (406) may then provide the poll initiator (402) with a list (408) of all random character strings assigned to the invited participants (418). In certain embodiments, the computerized anonymizing system (406) may provide the poll initiator (402) with more random character strings sets than there are participants in the list of participants. This may provide the poll initiator (402) with “dummy” access information, thus increasing the anonymity of poll participants (418), particularly in polls having fewer participants. The poll initiator (402) may then use the random character strings to set up access for the participants (418) through a computerized poll. In certain embodiments, the computerized poll may be accessed over the Internet. Additionally or alternatively, the computerized poll may be accessed only from a specific computer system. The poll initiator (402) may have no way of tying the random character strings (410, 412) to the participants (418) of the poll, thus ensuring privacy of the participant's (418) responses.

In addition to providing the poll initiator (402) with the list of random character strings, each participant (418) may receive the one or more character strings (410, 412) assigned to him or her by the computerized anonymizing system (406). The computerized anonymizing system (406) may send at least one random character string (410, 412) through one mode of communication to its corresponding participant (418). If more than one random character string is assigned to each user and the computerized anonymizing system (406) is provided with at least two addresses for a participant (418), the computerized anonymizing system may send one random character string (410) to one address and another random character string (412) to another address. In certain embodiments, these addresses may correspond to different modes of communication. For example, in FIG. 4 a participant (418) may receive one random character string (410) via a text message on a mobile phone (414) and another random character string (412) via email (416).

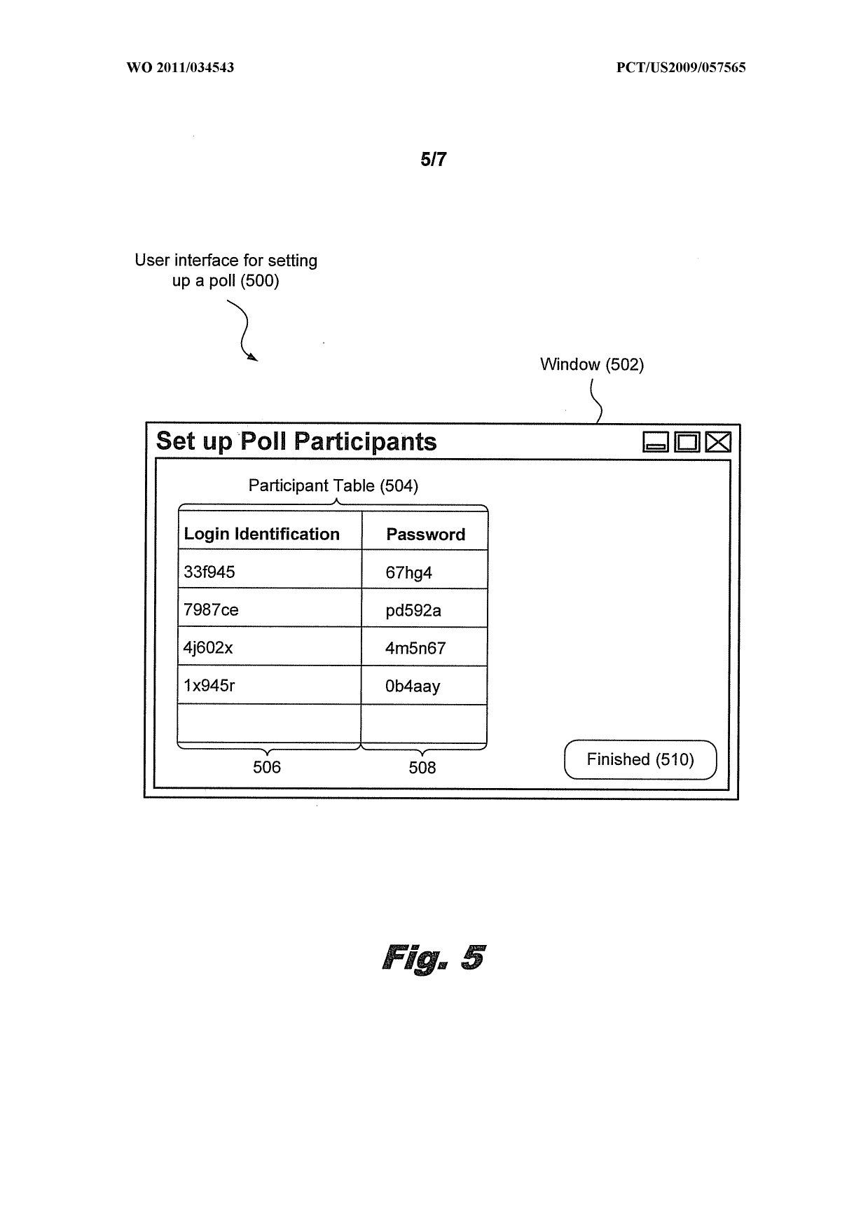

As mentioned above, upon receipt of a list of random character strings (408), the poll initiator (402) may set up access to a computerized poll. FIG. 5 is a diagram showing an illustrative user interface (500) for setting up a poll. According to one illustrative embodiment, the user interface (500) may include a window (502). The window (502) may include a participant table (504) having a login identification column (506) and a password column (508). The window (502) may also include a finished button (510).

The participant table (504) may be configured to allow a poll initiator (402, FIG. 4) to enter participant access information. The access information may include login identification (506) and a password (508). In a traditional computerized poll, the poll initiator (402, FIG. 4) would choose login identifications and passwords for each of the participants. This method provides a way for the poll initiator (402, FIG. 4) to tie the responses received from the computerized poll to a specific user. When using a computerized anonymizing system embodying principles described herein, the poll initiator (402, FIG. 4) may have random character strings anonymously assigned to poll participants (418, FIG. 4) by an external process to configure as poll access credentials. Since the poll initiator (402) has no access to information regarding the assignment of the random character strings to participants (418, FIG. 4), this may ensure that the poll is conducted in privacy. The poll initiator (402, FIG. 4) may click the finished button (510) after entering all the access information from the received random character string list (408, FIG. 4).

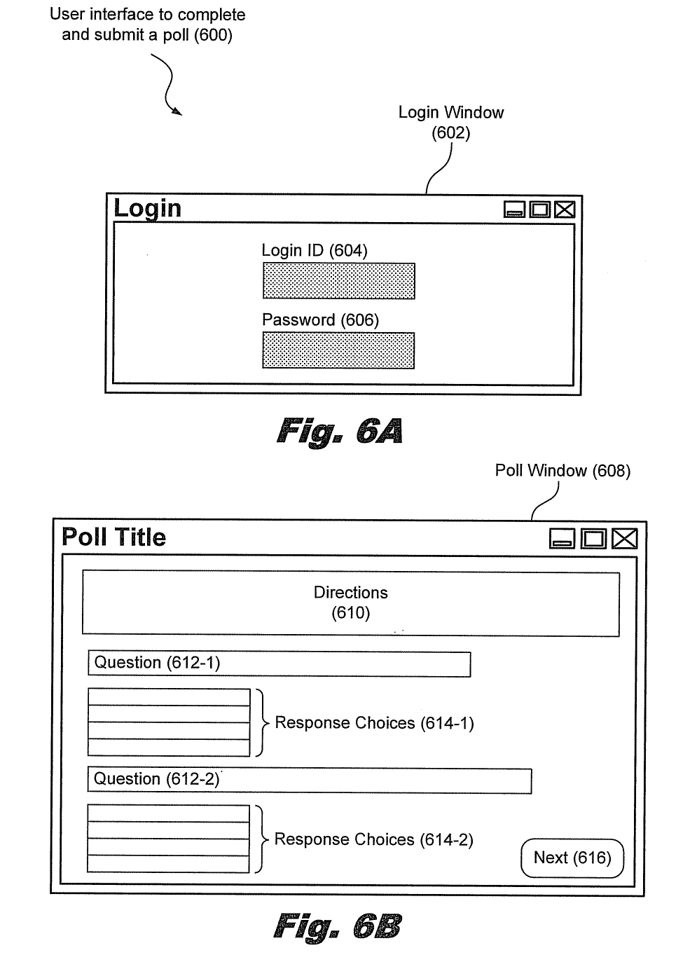

After the computerized anonymizing system has received the participant list and created at least one random character string for each participant (418, FIG. 4) from the list of participants. The participants (418, FIG. 4) may then receive random character strings from the computerized anonymizing system (400, FIG. 4) through one or more modes of communication. The participants are required to present their received random character strings to access a computerized poll. FIGS. 6A and 6B are diagrams showing an illustrative user interface for completing and submitting a poll (600).

FIG. 6A is a diagram showing an illustrative login window (602) for a poll. According to one illustrative embodiment, the user may be required to enter a login ID (604) and a password (606). Both the login ID and the password may be the random character strings received through different modes of communication from the computerized anonymizing system. In one embodiment, the login ID and password may come to a participant through the same mode of communication. In alternative embodiments, only one random character string used as an access ID may be required to access the computerized poll.

FIG. 6B is a diagram showing an illustrative poll window (608) which may appear after a participant has used the received random character strings to access the computerized poll. The poll window (608) may include directions (610) for completing the poll. The poll window may also include questions (612-1, 612-2) for the participants to respond to as well as response choices (614-1, 614-2). The poll window may provide a next button (616) for the participant to click on when finished with the poll questions (612-1, 612-2) currently shown in the window (608). If there are no additional poll questions to be answered, the next button (616) may change into a finished button. When the finished button is clicked, the poll may be submitted to the poll initiator.

In one embodiment, a participant may be allowed to access the computerized poll for a set amount of time after the poll opens. This may allow the participant to view their responses or change their responses if the poll has not yet been finalized. In some embodiments, the participant may have access to the final results of the poll.

The above described user interfaces which are illustrated in FIG. 5, FIG. 6A, and FIG. 6B are merely examples of possible interface configurations. The examples are used to illustrate various aspects of the principles described herein and in no way limit the practice of the computerized anonymizing system described herein.

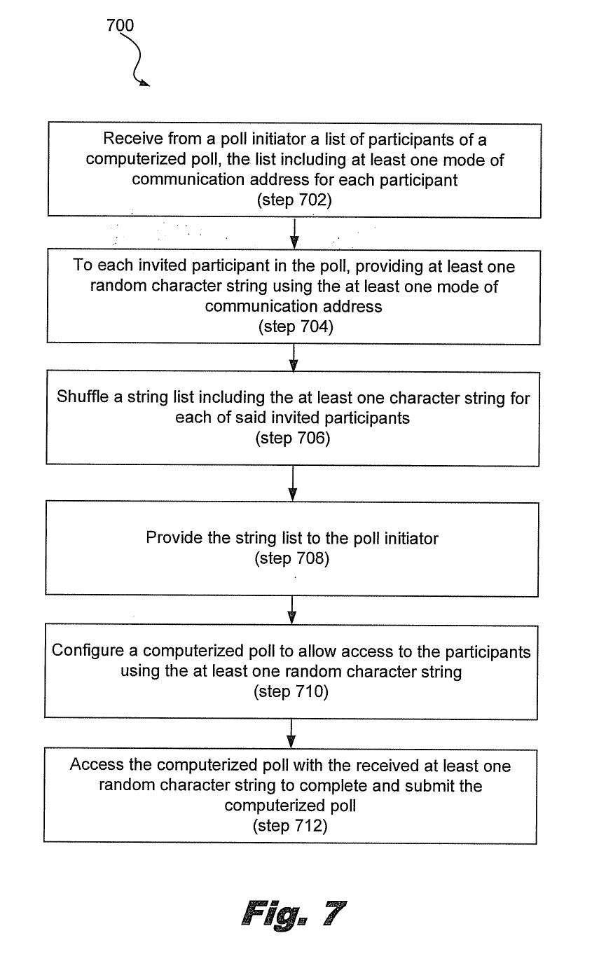

FIG. 7 is a flowchart showing an illustrative process for performing a privacy ensured poll. According to one illustrative embodiment, a method (700) for conducting a privacy ensured poll using a computerized anonymizing system may include the computerized anonymizing system receiving (step 702) from a poll initiator a list of participants of a computerized poll. The list may include at least one mode of communication address for each participant. The method may further include the computerized anonymizing system providing (step 704) to each invited participant in the poll at least one random character string using the at least one mode of communication address. The computerized anonymyzing system may then shuffle (step 706) a string list including the at least one character string for each of the invited participants and provide (step 708) the string list to the poll initiator. The method may further include the poll initiator configuring (step 710) a computerized poll to allow participants access to the poll using the at least one random character string, a participant accessing (step 712) the computerized poll using the at least one random character string to complete and submit the computerized poll.

In sum, a poll initiator may use a third party computerized anonymizing system. A computerized anonymizing system may be configured to receive from a poll initiator a list of participants. The list of participants may include for each participant an address for at least one mode of communication. The computerized anonymizing system may then assign a random character string to each participant. Each random character string may be sent to each participant through the associated mode of communication. A list of all of the random character strings assigned to each participant may be sent to the poll initiator. The poll initiator may use the list of random character strings to set up access for the poll participants. The poll initiator may have no way of associating the random character strings with the poll participants. The participants may then access the poll with the random character strings received through the two modes of communication. Upon access, the participants may complete and submit the poll.

Using a computerized anonymizing system embodying principles described herein may assure participants that their poll responses are anonymous. This in turn will make it more likely that the poll indicates the true views, votes, or opinions of the participants.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method for conducting a privacy ensured computerized poll, the method comprising:
in a computerized anonymizing system (100), receiving a list (404) of invited participants (418) of said computerized poll, said list (404) of invited participants (418) comprising at least one address (202, 204) for each said invited participant (418);
with said computerized anonymizing system (100), assigning each said invited participant (418) in said computerized poll at least one character string (410, 412) and transmitting to each said invited participant (418) said at least one character string (410, 412) assigned to said invited participants (418) using said at least one address (202, 204);
with said computerized anonymizing system (100), generating a string list (408) comprising an entry for each said at least one character string (410, 412) assigned to one of said invited participants (418) and shuffling an order of said entries; and
providing said shuffled string list (408) to a poll initiator (402).

2. The method of claim 1, further comprising allowing said poll initiator (402) to create a plurality of participant accounts for said computerized poll, each said invited participant account being accessible using one of said at least one character strings (410, 412) comprising an entry in said shuffled string list (408).

3. The method of any preceding claim, in which said character strings (410, 412) are generated randomly by said computerized anonymizing system (100).

4. The method of any preceding claim, further comprising deleting data indicating which said at least one character string (410, 412) is assigned to which said invited participant (418).

5. The method of any preceding claim, further comprising, if said list (404) of participants (408) comprises more than one address for each said participant (418), assigning a said character string (410, 412) to each said participant (418) for each said address (202, 204) and transmitting each said character string (410, 412) assigned to said participant (418) to its corresponding address (202, 204).

6. The method of any preceding claim, in which a length of each said character string (410, 412) is dependent upon a level of security required for said computerized poll.

7. The method of any preceding claim, further comprising expanding said shuffled string list (408) by generating additional entries of character strings (410, 412) for said shuffled string list (408), said additional entries not corresponding to any of said invited participants (418).

8. The method according to any of claims 1-3 or 5-7, further comprising encrypting and storing data indicating which said at least one random character string (410, 412) is assigned to which participant (418).

9. A computerized anonymizing system (100), the system comprising:
at least one processor (108) configured to execute polling software (104) stored in computer readable memory communicatively coupled to said processor (108), such that said processor (108) is configured to, upon execution of said polling software (104):
receive a list (404) of invited participants (418) of a computerized poll, said list comprising at least one address (202, 204) for each said invited participant (418);
assign each said invited participant (418) in said poll at least one character string (410, 412) and transmit to each said invited participant (418) said at least one character string (410, 412) assigned to said participant (418) using said at least one address (202, 204);
generate a string list (408) comprising a plurality of entries, each entry comprising said at least one character string (410, 412) assigned to one of said invited participants (418) and randomize an order of said entries in said string list (408); and
provide said randomized string list (408) to a poll initiator (402).

10. The computerized anonymizing system (100) of claim 9, in which said processor (108) is communicatively coupled to a network, and said processor (108) is further configured to transmit to each said invited participant (418) said at least one character string (410, 412) assigned to said participant (418) through said network.

11. The computerized anonymizing system (100) according to any of claims 9 or 10, in which said processor (108) is further configured to allow said poll initiator (402) to create a plurality of participant accounts for said computerized poll, each said participant account being accessible using one of said at least one character strings (410, 412) comprising an entry in said randomized string list (408).

12. The computerized anonymizing system (100) according to any of claims 9-11, in which said processor (108) is further configured to generate additional entries for said string list (408), said additional entries not corresponding to any of said invited participants (418).

13. The computerized anonymizing system (100) according to any of claims 9-12, in which said processor (108) is further configured to encrypt and store data indicating which of said at least one random character strings (410, 412) is assigned to which of said invited participants (418).

14. A computer program product for conducting anonymous polls, the computer program product comprising:
a computer readable storage medium (106) having computer readable code embodied therewith, the computer readable program code comprising:
computer readable program code configured to:
receive a list (404) of invited participants (418) of a computerized poll, said list (404) of invited participants (418) comprising at least one address (202, 204) for each said invited participant (418);
assign each invited participant (418) in said computerized poll at least one character string (410, 412) and transmit to each said invited participant (418) said at least one character string (410, 412) assigned to said invited participant (418) using said at least one address (202, 204);
generate a string list (408) comprising a plurality of entries, each entry comprising said at least one character string (410, 412) assigned to one of said invited participants (418) and randomize an order of said entries in said string list (408); and
provide said randomized string list (408) to a poll initiator (402).

15. The computer program product of claim 14, in which said computer readable program code further comprises computer readable program code configured to allow said poll initiator (402) to create a plurality of participant accounts for said computerized poll, each said participant (418) account being accessible using one of said at least one character strings (410, 412) comprising an entry in said randomized string list (408).
